(19) United States
(12) Patent Application Publication
(10) Pub. No.: US 2012/0268248 A1
(43) Pub. Date: Oct. 25, 2012

(54) Authentication Device and Authentication Method for Portable Information Terminal

(75) Inventor: Yoshifumi Hiraide, Tokyo (JP)

(73) Assignee: Shinten Sangyo Co., Ltd., Tokyo (JP)

(21) Appl. No.: 13/196,876

(22) Filed: Aug. 2, 2011

(30) Foreign Application Priority Data
Apr. 21, 2011 (JP) 2011-108772

(51) Int. Cl. G06F 7/04

(52) U.S. Cl. 340/5.83

(57) ABSTRACT

A portable information terminal such as a cellular phone terminal, a tablet type terminal, or an electronic book reader is set to be used only by an identical user. A touch panel type operation panel capable of using a touch panel mode and a fingerprint sensor mode as a common mode is disposed at a portable information terminal. A fingerprint sensing function is incorporated for performing authentication of a user's fingerprint and the fingerprint sensor mode and the touch panel mode can be used as a common mode. The operation panel is configured to display a fingerprint sensor portion 12 at a predetermined position as being in the fingerprint sensor mode when the portable information terminal is turned on, and then fingerprint authentication is performed by obtaining fingerprint information when pressing operation is performed on the fingerprint sensor portion for a predetermined time.

### CROSS-REFERENCE TO RELATED APPLICATIONS

This application is based on and claims the benefit of priority from Japanese Patent Application No. 2011-108772, filed on, Apr. 21, 2011, the entire contents of which are hereby incorporated herein by reference.

### BACKGROUND OF THE INVENTION

1. Field of the Invention

The present invention relates to a portable information terminal such as a portable communication terminal (e.g., a cellular phone etc.), a tablet type terminal, an electronic book reader and the like, and in particular, relates to an authentication device for a portable information terminal which can be brought into a device-started state by performing logon authentication operation thereof.

2. Description of the Related Art

Portable information terminals such as portable communication terminals (e.g., cellular phone terminals etc.) with a fingerprint sensor have been developed. Accordingly, there have been proposed various techniques to unlock an apparatus lasing fingerprint authentication for security purposes at a cellular phone and the like.

For example, with such a cellular phone terminal etc., a fingerprint sensor is arranged in an exposed manner so as to detect a fingerprint of a user's finger as the finger is being contacted to a sensor face or being moved with contacting to the sensor face. Fingerprint authentication is performed using the fingerprint information detected as described above (for example, see Japanese Patent Laid-open 2008-5147 and Japanese Patent Laid-open 2007-82139).

In general, such fingerprint authentication is performed by verifying the above fingerprint detection information with fingerprint authentication information which is previously stored in the terminal to determine whether the two match. Accordingly, the portable information terminal allows usage by an owner thereof and prevents usage by persons other than the owner.

Here, it has been strongly desired for a portable communication terminal and the like such as the abovementioned cellular phone terminal to ensure a security function as preventing unauthorized usage by other persons than the owner.

In particular, since such of portable communication terminals are to be carried by a user, it has been desired to be capable of preventing unauthorized usage by persons other than the owner at the time of loss or theft, for example.

However, as described above, since the fingerprint sensor is arranged simply in an exposed manner at a part of a terminal apparatus other than portions for an operation panel and operation buttons, the related-art portable information terminal increases the number of constituent parts and thus also cost.

### SUMMARY OF THE INVENTION

To address the above issues, the present invention provides an authentication device and an authentication method. for a portable information terminal in which the portable information terminal, such as a cellular phone, a tablet type terminal, or an electronic book reader, can be easily structured with the requisite minimum number of parts, achieving structural simplification and cost reduction with superior operability. In addition, it is possible to easily and reliably prevent unauthorized, usage at the time of loss or theft.

In view of the above, the present invention provides an authentication device for a portable information terminal with a touch panel type operation panel configured to display a variety of operation icons. Here, the operation panel having a fingerprint sensing function incorporated for performing authentication of a user's fingerprint is configured to use a fingerprint sensor mode and a touch panel mode as a common mode. The operation panel is configured to display a fingerprint sensor portion at a predetermined position as being in the fingerprint sensor mode when the portable information terminal is turned on. Then, fingerprint authentication is performed as obtaining fingerprint information when pressing operation is performed on the fingerprint sensor portion for predetermined time.

According to the present invention, the predetermined time is in the order of about two seconds for continuous pressing operation in the authentication device for a portable information terminal of claim 1.

According to the present invention, a fingerprint registration depot to which the portable information terminal is connected via the Internet and which performs fingerprint authentication by verifying the fingerprint information with previously registered fingerprint registration information is included in the authentication device for a portable information terminal of claim 1 or claim 2. Here, the portable information terminal includes external signal transmitting means which transmits the fingerprint information to the outside while being communicably connected to a variety of websites on the Internet, and then, fingerprint authentication is performed at the fingerprint registration depot.

According to the present invention, the operation panel is configured to detect finger motion or positional variation of pressure applied to a contact face of the fingerprint sensor portion while having a function as a fingerprint sensor in the authentication device for a portable information terminal of any one of claims 1 to 3. Here, a cursor or a pointer is to be moved on a face of the operation panel of the portable information terminal as being based on the detected information.

The present invention provides an authentication method for a portable information terminal with a touch panel type operation panel configured to display a variety of operation icons. Here, the operation panel having a fingerprint sensing function incorporated for performing authentication of a user's fingerprint is configured to use a fingerprint, sensor mode and a touch panel mode as a common mode. The operation panel is configured to display a fingerprint sensor portion at a predetermined position as being in the fingerprint sensor mode when the portable information terminal is turned on. The method includes displaying the fingerprint sensor portion on the operation panel at the time of turning-on, performing pressing operation onto the fingerprint sensor portion for a predetermined time, and performing fingerprint authentication with an authentication device as obtaining fingerprint information.

As described above, according to the authentication device and the authentication method for a portable information terminal of the present invention, the fingerprint sensor portion is to be displayed at a part of the operation panel and the terminal can be operated by performing pressing operation onto the fingerprint sensor portion. Therefore, notwithstanding the simplified structure, a variety of superior effects can be obtained as the portable information terminal, such as a cellular phone, a tablet type terminal, or an electronic book reader, can be easily structured with the requisite minimum number of parts, achieving structural simplification and cost reduction with superior operability.

In particular, according to the present invention having the abovementioned structure, the portable information terminal is activated by authentication at the fingerprint sensor portion, Therefore, superior effects can be obtained to easily and reliably prevent unauthorized usage, for example, at the time of loss or theft, as easily and reliably ensuring to be used only by an identical user.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, in which like reference numerals designate identical or corresponding elements, wherein:

FIG. 1 is a schematic structural view of a communication network illustrating an embodiment of an authentication device for a portable information terminal according to the present invention;

FIG. 2 is an explanatory view of performing registration, reading and authentication of an authentication device for the portable information terminal with a fingerprint registration depot via the Internet;

FIG. 3 is a schematic explanatory view illustrating a state that an icon to be a fingerprint sensor portion is displayed at the portable information terminal;

FIG. 4 is a schematic explanatory view illustrating a state in which the fingerprint sensor portion is operated at the portable information terminal;

FIG. 5A is a flowchart describing a registration procedure of fingerprint information at the fingerprint registration depot and FIG. 5B is a flowchart describing an authentication procedure of fingerprint information at the fingerprint registration depot; and

FIG. 6 is a flowchart describing a procedure of electronic authentication at the fingerprint registration depot and electronic payment.

### DETAILED DESCRIPTION OF THE EMBODIMENTS

In describing preferred embodiments illustrated in the drawings, specific terminology is employed for the sake of clarity. However, the disclosure of the present invention is not intended to be limited to the specific terminology so selected, and it to be understood that each specific element includes all technical equivalents that operate in a similar manner and achieve a similar result.

A portable information terminal is set to be used only by an identical user owing to performing authentication with the identical user as integrally arranging a fingerprint sensor with an operation panel as a touch panel.

### First Embodiment

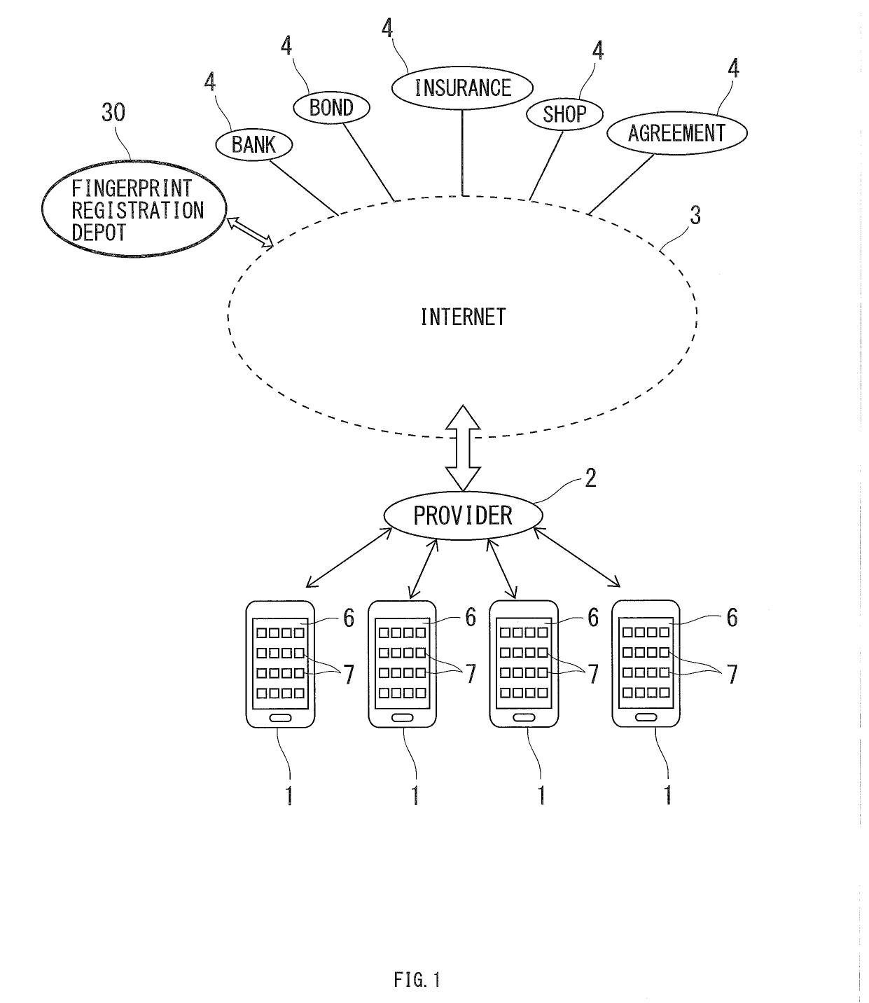

An embodiment of an authentication device and an authentication method for a portable information terminal according to the present invention will be described with reference to FIGS. 1 to 4.

In the drawings, a portable information terminal 1 being a tablet type terminal is appropriately connected to the Internet 3 via a provider 2 so as to be accessible to a variety of websites via the Internet 3.

As is commonly known, diverse types exist as the variety of websites 4. The following exemplifies banking, stock trading, insuring and shopping, for example, in which electronic authentication, electronic payment and the like are performed for being connected to the website 4.

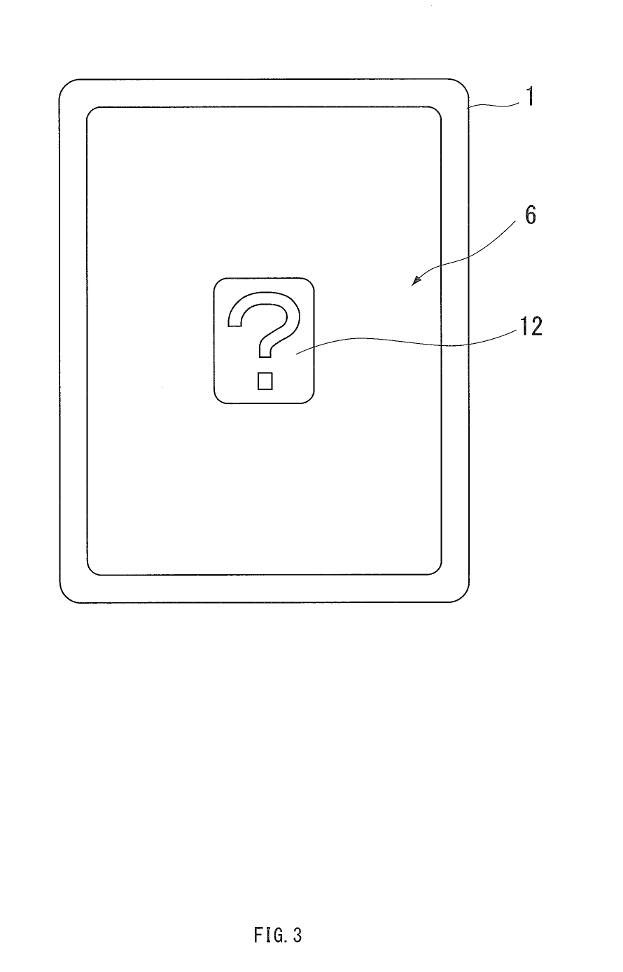

The present embodiment exemplifies a case in which the tablet type terminal is utilized for the portable information terminal. As illustrated in FIGS. 1, 3 and the like, the tablet type terminal 1 is provided with a touch panel type operation panel 6 having approximately the same size as one face of a terminal body and is configured to display icons 7 for various operations, various operation buttons, operation keys and the like.

According to the tablet type terminal 1 as the portable information terminal of the present invention, the operation panel 6 having a fingerprint sensing function incorporated for performing authentication of a user's fingerprint is configured so that a fingerprint sensor mode and a touch panel mode can be used as a common mode. That is, the operation panel 6 is configured to be in the fingerprint sensor mode when the terminal 1 is turned on as displaying a fingerprint sensor portion 12 at a predetermined position thereof as illustrated in FIG. 3. Then, fingerprint authentication is performed as obtaining fingerprint information when the fingerprint sensor portion 12 is operated to be pressed for a predetermined time.

Here, the fingerprint sensor portion 12 of the operation panel 6 is configured to perform authentication by detecting a fingerprint of a thumb F etc of a user's hand H as being turned on with pressing operation at a certain intensity continuously for about two seconds, for example.

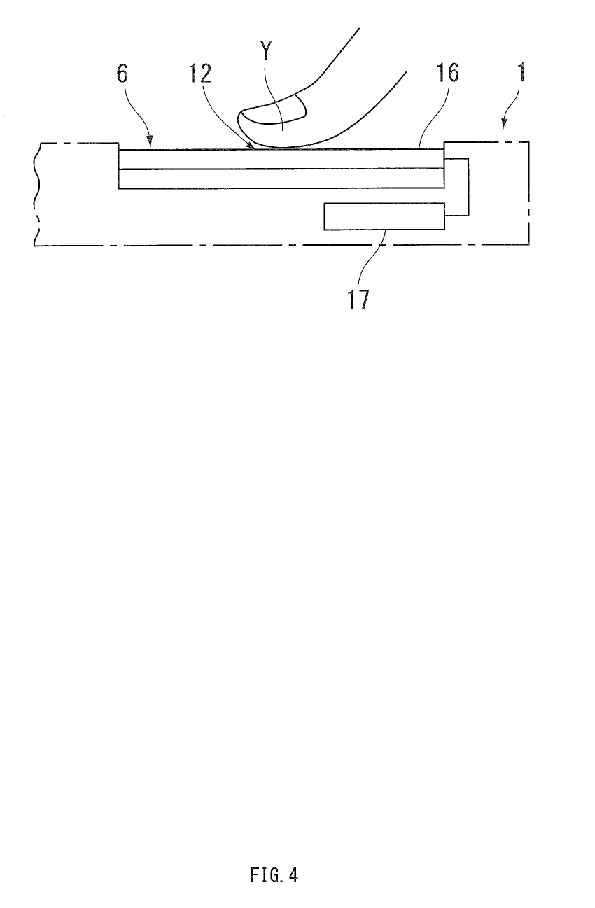

In FIG. 4, an operation panel plate 16 constituting the touch panel type operation panel 6 is appropriately provided with circuits and the like at both faces. A main substrate 17 is connected to the operation panel plate 16 via a flexible cable and the like. The touch panel type operation panel 6 is constituted with the above.

The above-structured operation panel 6 is configured to detect finger motion or positional variation of pressure applied to a contact face of the fingerprint sensor portion 12 while having a function as a fingerprint sensor in addition to functions of displaying and operating as a normal touch panel type. A cursor or a pointer is to be moved on a face of the operation panel of the portable information terminal as being based on the detected information.

Further, in the present embodiment, the tablet type terminal 1 as the above mentioned portable information terminal. is provided with external signal transmitting means to transmit, to the outside, the fingerprint information detected by the fingerprint sensor portion 12 while being communicably connected to the various websites 4 on the Internet 3. In addition, the tablet type terminal 1 is provided with a CPU which transmits, to the outside, the fingerprint information detected by the operation panel 6 and further has various functions necessary for the tablet type terminal 1.

Meanwhile, a fingerprint registration depot 30 is arranged so as to perform fingerprint authentication by verifying the fingerprint information with previously registered fingerprint registration information as the tablet type terminal 1 being connected thereto via, the Internet 3.

With the abovementioned structure, in the portable information terminal 1 having the touch panel type operation panel 6 capable of displaying the various operation icons 7, the operation panel 6 is configured to display the fingerprint sensor portion 12 at the predetermined position in the fingerprint sensor mode when the terminal 1 is turned on.

Then, the fingerprint sensor portion 12 is operated to be pressed over the predetermined time as displaying the fingerprint sensor portion 12 on the operation panel 6 when the terminal 1 is turned on (see FIG. 3 and the like). Owing to the above operation with the authentication device, fingerprint information is obtained and fingerprint authentication is to be performed.

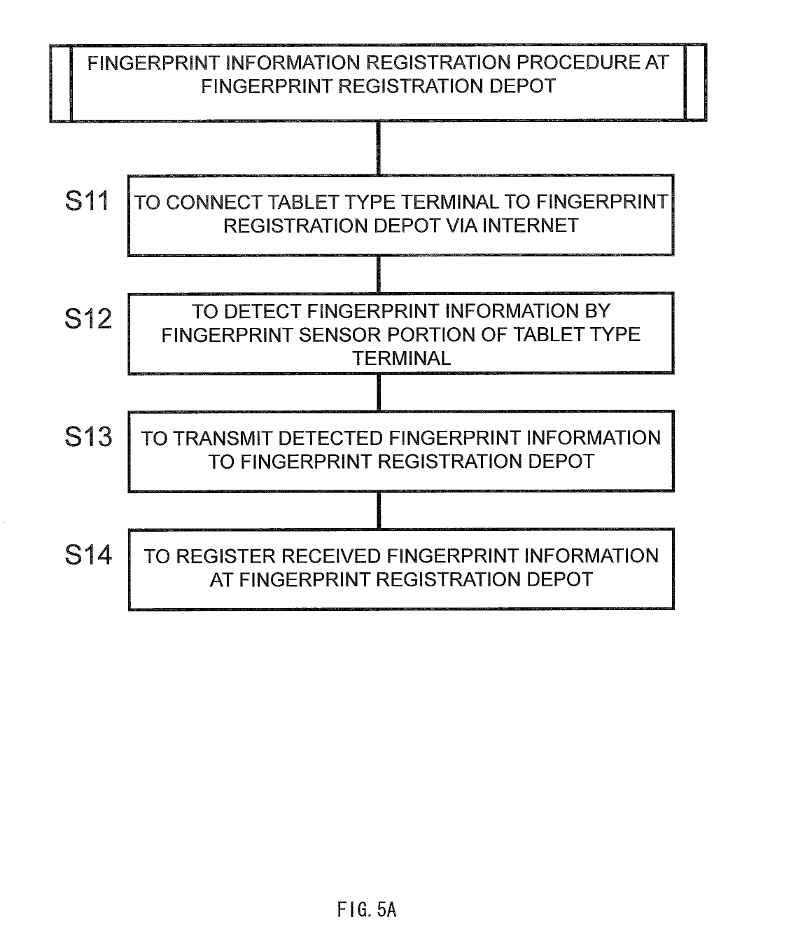

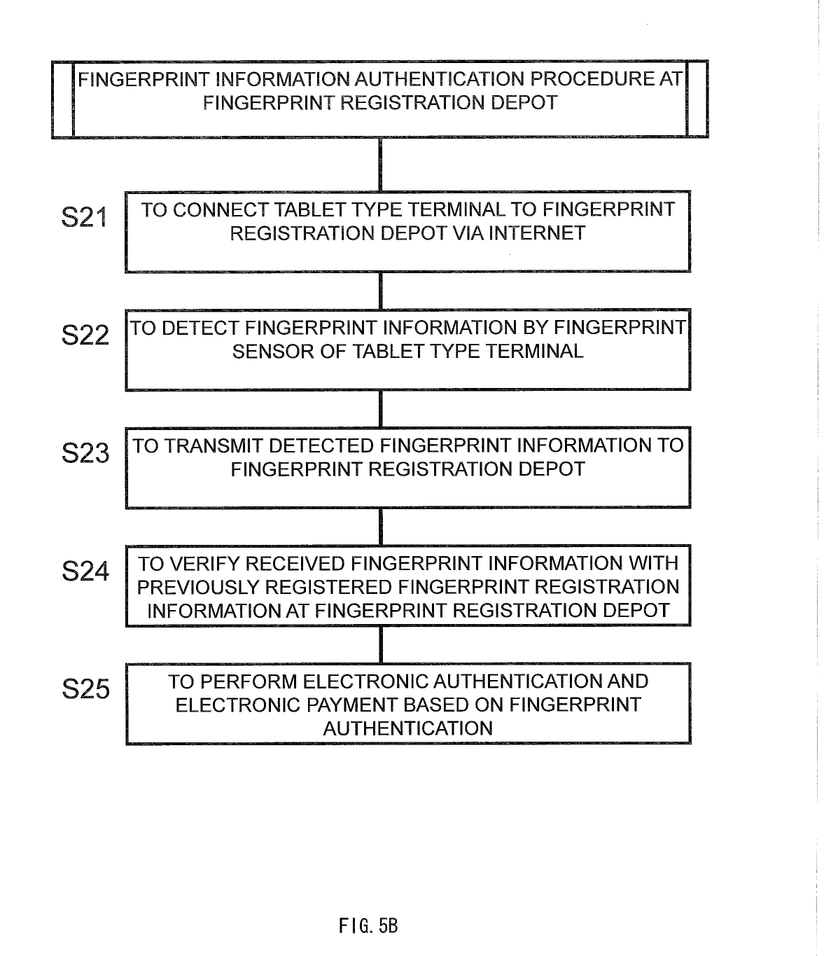

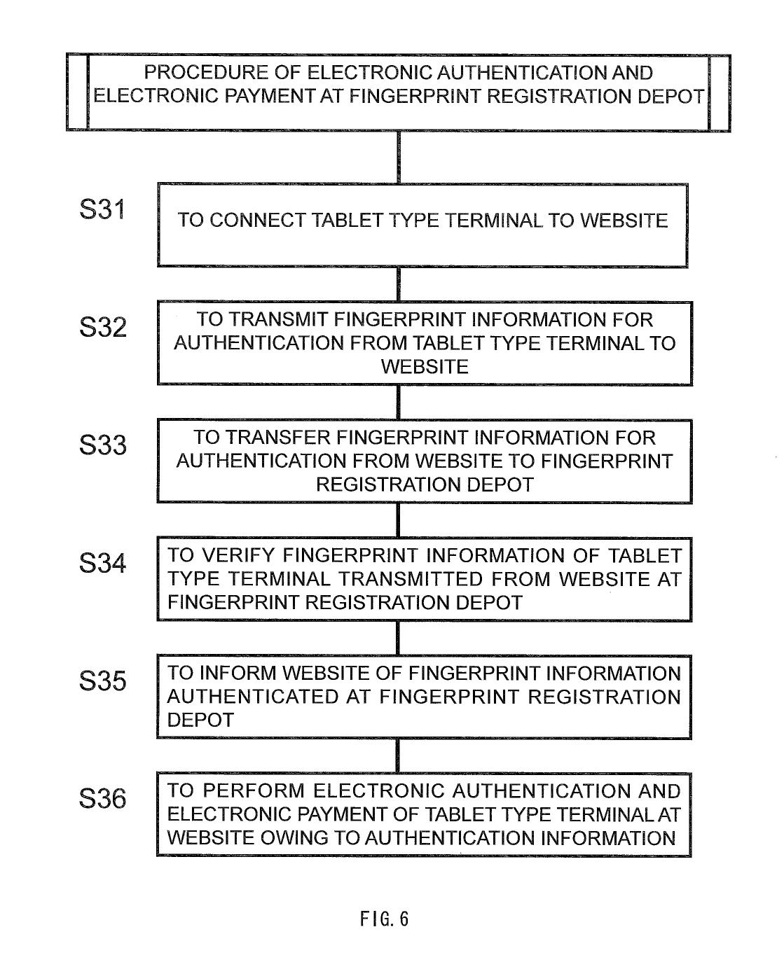

In the present embodiment, registration, authentication and the like are performed at the fingerprint registration depot 30 to perform fingerprint authentication by verifying the detected fingerprint information with the previously registered fingerprint registration information as the tablet type terminal 1 being connected thereto via the Internet 3. That is, with authentication at the fingerprint registration depot 30 as described in steps S21 to S25 of FIG. 5B, the terminal 1 becomes capable of being connected to various websites 4 via the Internet 3. Accordingly, electronic authentication and electronic payment are performed as the terminal 1 connected to the various websites 4 on the Internet 3.

Here, registration of the fingerprint information to the fingerprint registration depot 30 is appropriately performed, for example, with a procedure described, in steps S11 to S14 of FIG. 5A.

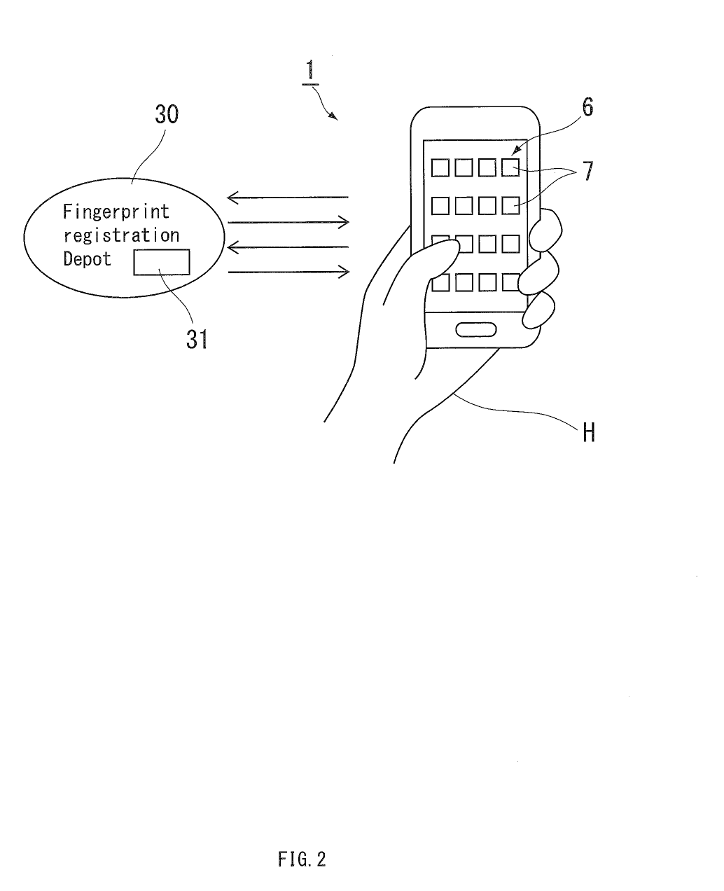

As illustrated FIG. 2, a security system 31 is arranged. at the fingerprint registration depot 30.

According to the authentication payment system of the above structure, when electronic authentication and electronic payment are performed on the tablet type terminal 1 against the various websites 4 on the Internet 3, the fingerprint registration information is required to be previously registered at the fingerprint registration depot 30 through the operation panel 20 capable of being used as a common mode of the fingerprint sensor mode and the touch panel mode as being arranged at the tablet type terminal 1.

As described in steps S31 to S36, the tablet type terminal 1 is connected to the fingerprint registration depot 30 via the Internet 3 in the touch panel mode of the operation panel 20 of the tablet type terminal 1 under such conditions. Further, the fingerprint information detected as a finger such as a thumb 22 and the like being contacted onto the operation panel 20 is transmitted to the fingerprint registration depot 30.

Then, verification is performed at the fingerprint registration depot 30 between the previously registered fingerprint registration information and the transmitted fingerprint information, and subsequently, determination is performed whether being matched or not. Then, determination is performed whether or not the access of the portable information terminal 1 is to be authenticated, and subsequently, the determination information is to be transmitted.

With the above authentication payment system, when it is required to perform electronic authentication and further electronic payment as being accessed from the tablet type terminal 1, each website 4 transmits the fingerprint information received from the tablet type terminal 1 to the fingerprint registration depot 30 and receives the determination therefrom. In this manner, electronic authentication and further electronic payment can be performed as determining whether or not the tablet type terminal 1 is with an authorized user.

Accordingly, it is possible to perform authentication and payment more reliably, as being superior in view of security compared to authentication and payment only with an ID and a password as in the related art.

Naturally, the fingerprint, registration depot 30 can be utilized to prevent widely-known unauthorized usage of the tablet type terminal 1.

Here, the present invention is not limited to the configuration described as the above embodiment. Accordingly, it is possible to appropriately modify or change the tablet type terminal 1 as the portable information terminal I and shapes and structures of respective portions constituting the authentication device which is adopted thereto.

For example, the fingerprint sensor portion 12 may be a sensor which is variously structured, in ways not limited to a widely-known pressure-sensitive sensor. In other words, it is only required to be capable of detecting fingerprint information.

Further, not limited to information obtained by scanning a fingerprint itself, the fingerprint information to be transmitted from the above tablet type terminal 1 and the like may be fingerprint information consisting of main portions extracted from a fingerprint or may be simplified information as being modeled through encryption thereof. With such information simplification, traffic for authentication and the like can be reduced and authentication speed can be heightened.

Numerous additional modifications and variations are possible in light of the above teachings. It is therefore to be understood that, within the scope of the appended claims, the present invention may be practiced otherwise than as specifically described herein.

What is claimed is:

1. An authentication device for a portable information terminal with a touch panel type operation panel configured to display a variety of operation icons,
wherein the operation panel having a fingerprint sensing function incorporated for performing authentication of a user's fingerprint is configured to use a fingerprint sensor mode and a touch panel mode as a common mode;
the operation panel is configured to display a fingerprint sensor portion at a predetermined position in the fingerprint sensor mode when the portable information terminal is turned on; and
fingerprint authentication is performed by obtaining fingerprint information when a pressing operation is performed on the fingerprint sensor portion for a predetermined time.

2. The authentication deice for a portable information terminal according to claim 1,
wherein the predetermined time is on the order of about two seconds for continuous pressing operation.

3. The authentication device for a portable information terminal according to claim 1, further comprising:
a fingerprint registration depot to which the portable information terminal is connected via the Internet and which performs fingerprint authentication by verifying the fingerprint information with previously registered fingerprint registration information;
wherein the portable information terminal includes external signal transmitting means which transmits the fingerprint information to the outside while being communicably connected to a variety of websites on the Internet; and
fingerprint authentication is performed at the fingerprint registration depot.

4. The authentication device for a portable information terminal according to claim 1,
wherein the operation panel is configured to detect finger motion or positional variation of pressure applied to a contact face of the fingerprint sensor portion while having a function as a fingerprint sensor; and
a cursor or a pointer is to be moved on a face of the operation panel of the portable information terminal as being based on the detected information.

5. An authentication method for a portable information terminal with a touch panel type operation panel configured to display a variety of operation icons,
wherein the operation panel having a fingerprint sensing function incorporated for performing authentication of a user's fingerprint is configured to use a fingerprint sensor mode and a touch panel mode as a common mode; and
the operation panel is configured to display a fingerprint sensor portion at a predetermined position as being in the fingerprint sensor mode when the portable information terminal is turned on;
the method comprising displaying the fingerprint sensor portion on the operation panel at the time of turning-on, performing pressing operation onto the fingerprint sensor portion for a predetermined time, and performing fingerprint authentication with an authentication device as obtaining fingerprint information.
